(19) United States
(12) Patent Application Publication
(10) Pub. No.: US 2015/0347674 A1
(43) Pub. Date: Dec. 3, 2015

(54) SYSTEM AND METHOD FOR ANALYZING BIOLOGICAL SAMPLE

(71) Applicants: SAMSUNG SDS CO., LTD., Seoul (KR); SAMSUNG LIFE PUBLIC WELFARE FOUNDATION, Seoul (KR)

(72) Inventors: Yoo-Jin HONG, Seoul (KR); Seong-Hyeuk NAM, Seoul (KR); Woo-Yeon KIM, Seoul (KR); Chang-Seok KI, Seoul (KR)

(73) Assignees: SAMSUNG LIFE PUBLIC WELFARE FOUNDATION, Seoul (KR); SAMSUNG SDS CO., LTD., Seoul (KR)

(21) Appl. No.: 14/556,628

(22) Filed: Dec. 1, 2014

(30) Foreign Application Priority Data
May 29, 2014 (KR) 10-2014-0064878

(51) Int. Cl. G06F 19/18

(52) U.S. Cl. CPC G06F 19/18

(57) ABSTRACT

There are provided a system and method for analyzing a biological sample. The system for analyzing a biological sample according to an embodiment of the present disclosure includes a first variation detecting unit configured to determine whether a plurality of pools each have a test target property according to a first determining reference value; an error determining unit configured to determine whether there is an error possibility in a determination result of the first variation detecting unit according to an alternative allele frequency of a pool that is determined as positive in a determination result of the first variation detecting unit; a second variation detecting unit configured to determine whether each of the plurality of pools has the test target property according to a second determining reference value when it is determined in the error determining unit that there is the error possibility; and a test result determining unit configured to determine whether each of the plurality of samples has the test target property according to determination results of the first variation detecting unit and the second variation detecting unit.

### CROSS-REFERENCE TO RELATED APPLICATION

This application claims priority to and the benefit of Korean Patent Application No. 10-2014-0064878, filed on May 29, 2014, the disclosure of which is incorporated herein by reference in its entirety.

### BACKGROUND

1. Field

Embodiments of the present disclosure relate to technology for analyzing a biological sample.

2. Discussion of Related Art

As examples in which a blood sample is tested to know a specific virus infection or whether a genetic variation causing a specific disease is included, in order to test whether a biological sample of a target to be tested has a specific property, the test was individually performed on each sample of the target, generally. Therefore, when a large number of a sample needs to be tested, time and cost for performing repetitive tests for each sample were necessary. However, when a screening test of a disease having a low incidence is performed, most samples to be tested show a negative result. Therefore, in order to decrease a test cost, a pooling test method in which two or more samples were pooled, the pooled samples were tested, and it was determined whether there was a sample having a tested specific property among the pooled samples was proposed. Further, methods in which a sample having a corresponding property can be identified among the pooled samples were proposed. Such pooling tests are advantageous in that a test cost decreases, but sensitivity may decrease compared to an individual test due to tests of several samples at the same time.

Errors in the pooling test result mainly occur when pooled individual samples are not reflected in a pooled sample (a pooled sample, hereinafter referred to as a “pool”) at the same ratio or a desired ratio. The cause thereof may be various. A DNA concentration difference between samples pooled in one pool may be one cause. In general, in order to perform the pooling test, one sample is pooled in two or more pools, the test is performed on the pool in which the sample is pooled, and a positive sample may be identified according to whether any pool is shown as positive. In this case, the positive sample refers to a sample having a variation, and the positive pool indicates that there is the positive sample among samples pooled in the pool.

As a method of measuring a signal for determining whether the pool is positive, next generation sequencing (hereinafter referred to as “NGS”) technology may be used. In the NGS technology, a large amount of reads which are sequence fragments having a pre-determined length are generated with respect to a genomic region serving as a target. The reads generated in this manner are mapped to a reference sequence, and a sequence of the region is re-constructed based on sequence information of the reads mapped to the specific region. A genotype of a specific position may be derived as an alternative allele frequency in a corresponding position in reads mapped to a region including the corresponding position. For example, in a heterozygous genotype AB, it may be observed that alternative allele frequencies of A and B in reads are about ½ and ½, respectively. When two samples having a genotype AB and a genotype BB, respectively, are pooled, it may be observed that alternative allele frequencies of A and B in the pool are about ¼ and ¾, respectively. Therefore, in order to test whether the sample has a variation using the NGS technology, an alternative allele frequency of an alternative allele B in the variation genotypes AB and BB is measured based on the mapped read. However, this method assumes that samples pooled in one pool are included in the pool at the same ratio. When the positive sample is pooled in the pool at a low ratio, the alternative allele frequency observed in the pool may be lower than a desired level, and the corresponding pool is likely to be determined as negative. When some pools in which the corresponding sample is pooled show a negative result, it is difficult to accurately determine whether the sample is positive.

### SUMMARY

Embodiments of the present disclosure provide a method of improving test sensitivity when a pooling test is performed to know whether there are genetic variations by pooling a plurality of samples.

According to an aspect of the present disclosure, there is provided a system for analyzing biological samples. The system comprises a first variation detector configured to determine whether a pool of the samples has a test target property based on a first determining reference value; an error determining processor configured to determine whether a probability of error exists in a determination of the first variation detector based on an alternative allele frequency of the pool in response to the first variation detector determining the pool as positive; a second variation detector configured to determine whether the pool has the test target property based on a second determining reference value in response to the error determining processor determining that the probability of error exists; and a test result determining processor configured to determine whether each of the samples has the test target property based on the determination of the first variation detector and a determination of the second variation detector.

The error determining processor may compare an alternative allele frequency of the pool determined as positive and a number of samples determined as positive in the pool.

The system may further comprises a signal pattern determining processor configured to determine whether an alternative allele frequency of a plurality of pools including the samples has an effective signal pattern in response to the error determining processor determining that the probability of error exists.

The signal pattern determining processor may group alternative allele frequencies of each of the plurality of pools into two clusters and determine whether an effective signal pattern exists based on an average value of alternative allele frequencies for each of the two clusters.

The signal pattern determining processor may determine that the effective signal pattern exists in response an average value of an alternative allele frequency per sample of one of the two clusters being a value in a range from 0 to 0.1 and an average value of an alternative allele frequency per sample of the other cluster being a value in a range from 0.4 to 1.

The second variation detector may determine whether each of the plurality of pools has the test target property based on the second determining reference value in response to the signal pattern determining processor determining that the alternative allele frequency of the plurality of pools has the effective signal pattern.

The second determining reference value may have a value smaller than the first determining reference value.

According to another aspect of the present disclosure, there is provided a method of analyzing biological samples. The method comprises first variation determining, by a first variation detector, whether a pool of the samples has a test target property based on a first determining reference value; determining, by an error determining processor, whether a possibility of error exists in a determination of the first variation detector based on an alternative allele frequency of the pool in response to the first variation detector determining the pool as positive; second variation determining, by a second variation detector, whether the pool has the test target property based on a second determining reference value in response to the error determining processor determining that the probability of error exists; and determining, by a test result determining processor, whether each of the samples has the test target property based on the determination of the first variation detector and a determination of the second variation detector.

The determining of whether the possibility of error exists may comprise comparing an alternative allele frequency of the pool determined as positive and a number of samples determined as positive in the pool.

The method may further comprise determining, by a signal pattern determining processor, whether an alternative allele frequency of a plurality of pools including the samples has an effective signal pattern in response to the error determining processor determining that the probability of error exists.

The determining whether the alternative allele frequency of the plurality of pools has the effective signal pattern may comprise grouping alternative allele frequencies of each of the plurality of pools into two clusters, and determining whether an effective signal pattern exists using an average value of alternative allele frequencies for each of the two clusters.

The determining whether the alternative allele frequency of the plurality of pools has the effective signal pattern may comprise determining that the effective signal pattern exists in response to an average value of alternative allele frequencies of the pools in one of the two clusters being a value in a range from 0 to 0.1 and an average value of alternative allele frequencies of the pools in the other cluster being a value in a range from 0.4 to 1.

The second variation determining may comprise determining whether each of the plurality of pools has the test target property based on the second determining reference value in response to the signal pattern determining processor determining that the alternative allele frequency of the plurality of pools has the effective signal pattern.

The second determining reference value may have a value smaller than the first determining reference value.

According to another aspect of the present disclosure, there is provided an analyzer for analyzing biological samples grouped by a plurality of pools. The analyzer comprises a first variation detector configured to determine that one of the plurality of pools has a target property based on a first reference value; a signal pattern processor configured to determine that an alternative allele frequency of the plurality of pools has an effective signal pattern; a second variation detector configured to determine that the one of the plurality of pools has the target property based on a second reference value in response to the signal pattern processor determining the alternative allele frequency has the effective signal pattern; and a test result determining processor configured to determine whether each of the samples has the target property based on determinations of the first variation detector and the second variation detector.

The signal pattern determining processor may group alternative allele frequencies of each of the plurality of pools into two clusters and determine whether an effective signal pattern exists based on an average value of alternative allele frequencies for each of the two clusters.

The signal pattern determining processor may determine that the effective signal pattern exists in response an average value of alternative allele frequencies of the pools in one of the two clusters being a value in a range from 0 to 0.1 and an average value of alternative allele frequencies of the pools in the other cluster being a value in a range from 0.4 to 1.

The second variation detector may determine whether each of the plurality of pools has the target property based on the second reference value in response to the signal pattern determining processor determining that the alternative allele frequency has the effective signal pattern.

The second reference value may have a value smaller than the first reference value.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a diagram illustrating a process of sample pooling according to an embodiment of the present disclosure;

FIGS. 2 to 5 are diagrams illustrating examples of determination errors in a sample pooling test according to embodiments of the present disclosure;

FIG. 6 is a block diagram illustrating a system for analyzing a biological sample 100 according to an embodiment of the present disclosure;

FIGS. 7 to 9 are diagrams illustrating examples of signal patterns in a sample pooling test according to embodiments of the present disclosure; and

FIG. 10 is a flowchart illustrating a method of analyzing a biological sample 1000 according to an embodiment of the present disclosure.

### DETAILED DESCRIPTION OF EXEMPLARY EMBODIMENTS

Hereinafter, exemplary embodiments of the present disclosure will be described in detail with reference to the drawings. However, these are only examples and the present disclosure is not limited thereto.

In descriptions of the disclosure, when it is determined that detailed descriptions of related well-known functions unnecessarily obscure the gist of the disclosure, detailed descriptions thereof will be omitted. Some terms described below are defined by considering functions in the disclosure and meanings may vary depending on, for example, a user or operator's intentions or customs. Therefore, the meanings of the terms should be interpreted based on the scope throughout this specification.

The spirit and scope of the disclosure are defined by the appended claims. The following embodiments are only made to efficiently describe the technological scope of the disclosure to those skilled in the art.

A system for analyzing a biological sample 100 according to an embodiment of the present disclosure is a system for determining whether a plurality of biological samples each have a specific biological property (in other words, shows a positive response for the specific property). Specifically, the system for analyzing a biological sample 100 is configured to determine whether the plurality of samples each have a test target property using a plurality of biological samples forming an n*m matrix and a plurality of pools that are generated by pooling samples having the same row or column in the matrix.

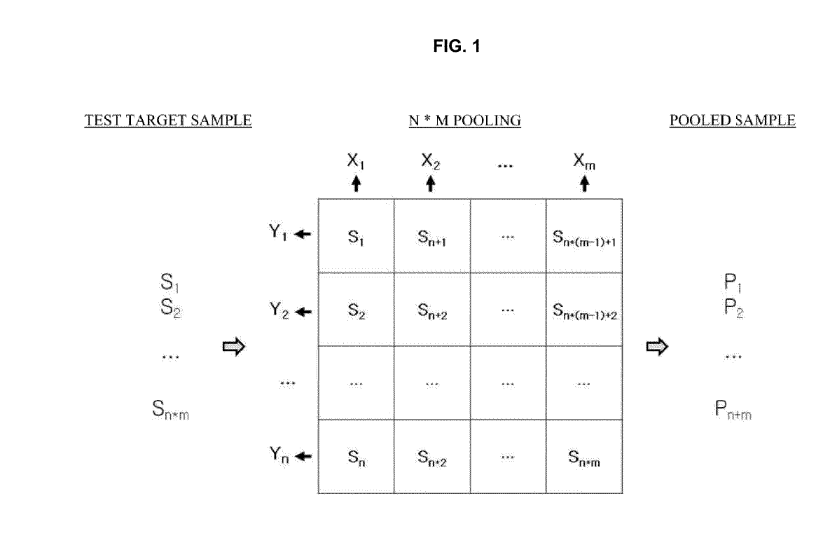

Before components of the system for analyzing a biological sample 100 according to the embodiment of the present disclosure are described, a process of forming a pool from a test target sample will be described with reference to FIG. 1. First, x (x=n*m) test target samples (S₁, S₂, . . . , and S_{n*m}) are arranged in the n*m matrix. In this case, n and m may be the same or different numbers, but n*m and x should be the same. Also, x is equal to or greater than 2. The test target sample is a specimen for testing whether the sample has a specific biological property, and may include tissues, body fluids, or the like of all organisms including a human.

When the matrix is formed as described above, next, x test target samples arranged in the matrix are pooled into k (=n+m) pools. In this case, samples in the same row or column of the matrix are pooled into the same pool. For example, in the illustrated embodiment, samples forming the first column of the matrix are pooled in a pool X₁, and samples forming the first row of the matrix are pooled in Y₁. Through this process, k pooled samples (X₁, . . . , Xₘ, Y₂, . . . , Yₙ, each hereinafter referred to as a “pool”) are generated.

Next, a test is performed on the k pools and a signal of a specific property to be tested is measured. In the embodiment of the present disclosure, the specific property may indicate whether each sample has a biological characteristic, for example, a genetic marker such as a specific single nucleotide polymorphism (SNP), a specific genotype of the genetic marker, and a specific disease. In the test, an intensity of a signal that indicates whether the sample has a specific property is approximately proportional to the number of samples having the corresponding property in the pool. For example, when the number of samples having the specific property in the pool is 2, the signal intensity according to the test may be about twice that of when the number thereof is 1. When the signal intensity measured in a specific pool is sufficient for determining that at least one sample included in the pool has the specific property, the pool may be referred to as positive for the specific property.

For example, it is assumed that the test checks whether samples have a specific SNP. In this case, any of a reference genotype AA, a heterozygous variation genotype AB, and a homozygous variation genotype BB may be in a corresponding variation position of genes included in the sample. In this example, a diploid is exemplified in order to facilitate understanding, but the present disclosure is not limited thereto. Also, as a method of measuring a signal of the variation genotype, next generation sequencing (hereinafter referred to as “NGS”) technology may be used. In the NGS technology, a large amount of reads which are sequence fragments having a predetermined length are generated with respect to a genomic region serving as a target. The reads generated in this manner are mapped to a reference sequence, and a sequence of the region is re-constructed based on sequence information of the reads mapped to the specific region.

In the above example, a genotype of a specific position of the test target sample may be derived as an alternative allele frequency in a corresponding position in reads mapped to a region including the corresponding position. For example, in the heterozygous genotype AB, it may be observed that alternative allele frequencies of A and B are about ½ and ½, respectively. Also, when a sample having a genotype AB and a sample having a genotype BB are pooled, it may be observed that alternative allele frequencies of A and B are about ¼ and ¾, respectively. Therefore, in order to test whether the sample has a specific SNP using the NGS technology, an alternative allele frequency of an alternative allele B in the variation genotypes AB and BB is measured based on the mapped read.

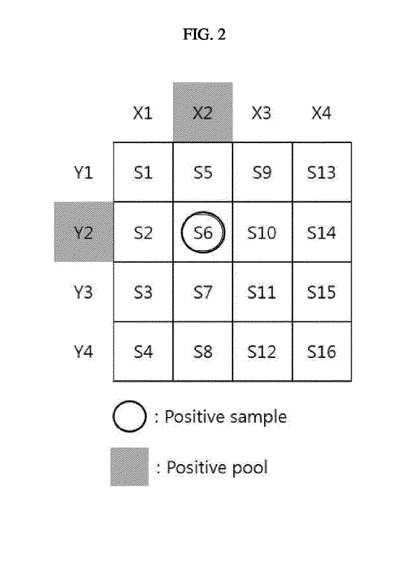

Meanwhile, in order to easily apply the NGS technology to the present disclosure, a condition in which sequencing reads of each sample pooled in a corresponding pool are approximately evenly distributed in the result obtained by sequencing each pool should be satisfied. For example, when four pooled samples have genotypes AA, AB, AB, and AA, respectively, it should be observed that the alternative allele frequency of the alternative allele B in the pool is about 2/8. However, when each sample forming the pool, and particularly, when a positive sample is not pooled in the pool at an appropriate ratio, the pool test result may be negative despite the positive sample. This will be exemplified with reference to FIGS. 2 to 5.

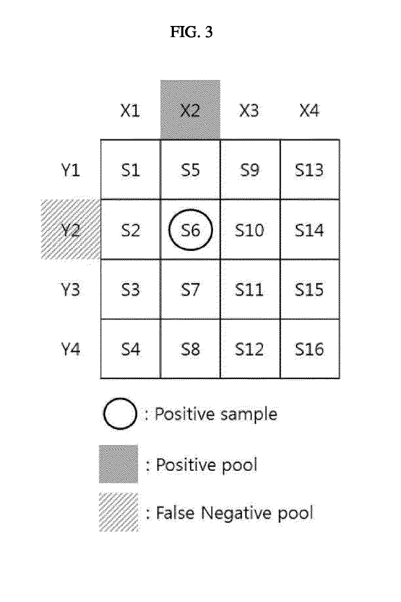

FIGS. 2 to 5 are diagrams illustrating examples of determination errors in a sample pooling test according to embodiments of the present disclosure. First, as illustrated in FIG. 2, when a sample S6 is a positive sample, two pools X2 and Y2 should be determined as positive. However, as illustrated in FIG. 3, when the pool Y2 is erroneously determined as negative, the sample S6 is erroneously determined as negative.

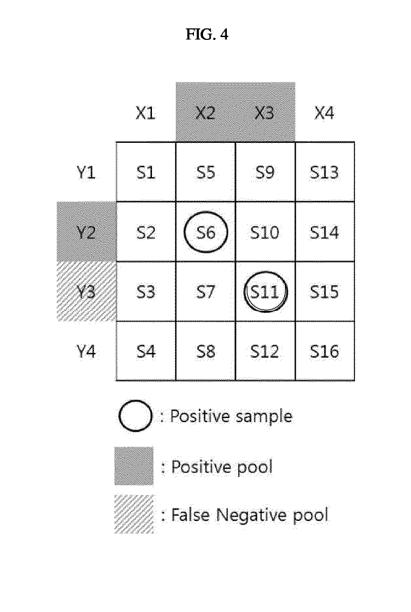

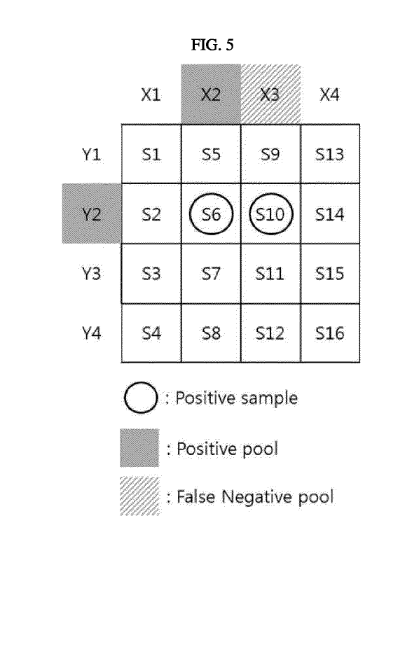

Also, as illustrated in FIG. 4, there are two positive samples S6 and S11. When the pool Y3 is erroneously determined as negative among four pools X2, X3, Y2, and Y3 that should be determined as positive, samples S10 and S11 are erroneously determined as positive and negative, respectively. FIG. 5 also shows a case in which the pool X3 that should be determined as positive is erroneously determined as negative, and the sample S10 that should be determined as positive is erroneously determined as negative. That is, in the sample pooling test, when some pools are determined as a false negative or a false positive, it influences a determination result of the entire sample.

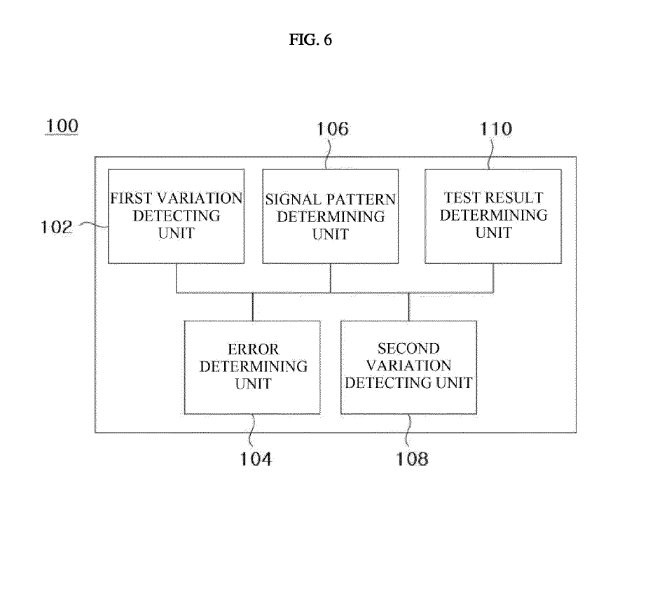

FIG. 6 is a block diagram illustrating the system for analyzing a biological sample 100 according to the embodiment of the present disclosure. As illustrated, the system for analyzing a biological sample 100 according to the embodiment of the present disclosure is a system configured to determine whether each of the plurality of samples has a test target property using a plurality of biological samples forming an n*m matrix and a plurality of pools that are generated by pooling samples in the same row or column of the matrix. The system includes a first variation detecting unit 102, an error determining unit 104, a signal pattern determining unit 106, a second variation detecting unit 108, and a test result determining unit 110.

The first variation detecting unit 102 determines whether each of the plurality of pools has a test target property according to a first determining reference value.

The error determining unit 104 determines whether there is an error possibility in the determination result of the first variation detecting unit according to an alternative allele frequency of a pool determined as positive based on the determination result of the first variation detecting unit 102.

When it is determined in the error determining unit 104 that there is the error possibility, the signal pattern determining unit 106 determines whether the alternative allele frequency of the plurality of pools has an effective signal pattern.

When it is determined in the error determining unit 104 that there is the error possibility or when it is determined in the signal pattern determining unit 106 that the alternative allele frequency of the plurality of pools has the effective signal pattern, the second variation detecting unit 108 determines whether each of the plurality of pools has the test target property according to a second determining reference value that is a value lower than the first determining reference value.

The test result determining unit 110 determines whether each of the plurality of samples has the test target property according to the determination results of the first variation detecting unit 102 and the second variation detecting unit 108.

Hereinafter, components of the system for analyzing a biological sample 100 according to the embodiment of the present disclosure configured as above will be described in detail.

### Standard Variation Detection in Pool (Normal Call)

First, the first variation detecting unit 102 determines whether the pool is positive (whether a test target property is included) by detecting a variation in each of the plurality of pools according to the first determining reference value.

For example, the first variation detecting unit 102 may determine whether the pool is positive based on the alternative allele frequency observed in the pool for each variation. When there is a sample having a variation among samples pooled in a specific pool and the variation is the heterozygous genotype, a minimum alternative allele frequency that is necessary to be determined as positive in the pool is observed. A reference value (the first determining reference value) of the minimum alternative allele frequency may be calculated as, for example, Equation 1. When the observed alternative allele frequency is greater than the calculated reference value, it may be determined that the pool is positive.

Reference value of minimum alternative allele frequency=α*(1/the number of samples pooled in a pool)

In Equation 1, when it is assumed that samples are pooled in the pool at the same ratio, α is a minimum value of an alternative allele frequency for each pool to be determined as positive by standard variation detection. For example, there is a sample having the heterozygous variation genotype AB in a pool in which four samples are pooled. Ideally, in the pool in which four samples are pooled, ¼ of the reads from the pool belongs to one sample, and the ratio between the numbers of reads having a genotype A and the numbers of reads having a genotype B in reads is about 1:1. In this case, the first variation detecting unit 102 may detect a variation by setting the minimum alternative allele frequency to 0.5. However, in consideration of a series of errors such as a sequencing error or a mapping error, a value of a may also be decreased and applied.

As described above, the method of determining whether the pool is positive using a minimum alternative allele frequency value is appropriate especially when the number of reads mapped to a corresponding variation position is sufficiently large. The first variation detecting unit 102 may be configured to check whether each pool is positive using statistical algorithms of calculating a likelihood or a probability of the genotype such as SNVer algorithm in addition to the above method. That is, the above-described rule or algorithm is only an embodiment for performing the present disclosure, and the present disclosure is not limited thereto.

### Determination of Error Possibility

Next, the error determining unit 104 determines whether there is an error possibility in the determination result of the first variation detecting unit according to the alternative allele frequency of the pool that is determined as positive in the determination result of the first variation detecting unit 102. Specifically, the error determining unit 104 determines whether there is a possibility of some pools among pools in which samples are pooled being erroneously determined as negative based on the positive pool. When it is determined that there is no error possibility in the determination result, the test result determining unit 110 determines whether samples pooled in each pool are positive based on pools determined as positive in the first variation detecting unit 102.

In an embodiment, the error determining unit 104 may determine whether there is the error possibility by comparing the number of samples determined as positive in the pool and the alternative allele frequency of the pool determined as positive in the determination result of the first variation detecting unit 102. As described above, since the alternative allele frequency of the pool is approximately proportional to the number of positive samples included in the pool, when the number of samples actually determined as positive is too large or too small compared to the alternative allele frequency of the specific pool, it may be determined that there is an error in the determination result of the first variation detecting unit 102.

For example, the error determining unit 104 may determine whether there is the error possibility using the following Equation 2. Equation 2 is used to calculate a probability of as many positive samples being included as the number of samples determined as positive in the pool, with respect to a positive pool. The error determining unit 104 may determine that there is the error possibility when there is a pool for which the calculated probability is equal to or less than a determined level.

$$Pr ( S \text{\textbar} AF ) = \frac{Pr ( AF \text{\textbar} S ) Pr ( S )}{\begin{matrix}Pr ( AF \text{\textbar} CommonVar ) Pr ( CommonVar ) + \\ Pr ( AF \text{\textbar} NotCommonVar ) Pr ( NotCommonVar ) +\end{matrix}} \qquad [ Equation 2 ]$$

In Equation 2, S denotes the number of positive samples in the pool, AF denotes an allele frequency observed in the pool, CommonVar denotes a variation that may commonly occur in a test target population, and NotCommonVar denotes a variation other than the CommonVar. The CommonVar may be, for example, a variation at a frequency of 1% or more in the 1000 Genomes project (Durbin et al. Nature 2010) data, but the present disclosure is not limited thereto.

Meanwhile, it should be noted that Equation 2 is only an example for determining the error possibility using the allele frequency of the pool and the number of positive samples in the pool, and the present disclosure is not limited thereto.

### Determining Whether Effective Signal Pattern is Detected

When it is determined in the error determining unit 104 that there is the error possibility, next, the signal pattern determining unit 106 determines whether an in depth variation detecting process through the second variation detecting unit 108 is necessary with respect to the pools (negative pools) in which no variation is detected through a standard variation detecting process of the first variation detecting unit 102. The signal pattern determining unit 106 determines whether the in depth detecting process is necessary based on whether the alternative allele frequency of the plurality of pools has the effective signal pattern.

Specifically, the signal pattern determining unit 106 may group alternative allele frequencies of each of the plurality of pools into two clusters and determine whether there is an effective signal pattern using an average value of alternative allele frequencies for each grouped cluster. In this case, the signal pattern determining unit 106 determines that there is the effective signal pattern when an average value of alternative allele frequencies of the pools in any of the two clusters is a value of 0 to 0.1, and an average value of alternative allele frequencies of the pools in the other cluster is a value of 0.4 to 1. This will be described in greater detail below.

The sample analyzing system 100 according to the embodiment of the present disclosure is mainly used to test whether the plurality of samples have a rare variation that is known to be related to an incidence of a disease. Therefore, a possibility of a sample having a specific rare variation among pooled samples is very low. Therefore, in case of a rare variation, an alternative allele frequency close to about 0 may be observed in most pools. Only in some pools (that is, pools in which a positive sample is pooled), the alternative allele frequency of a significant level for variation detection may be observed.

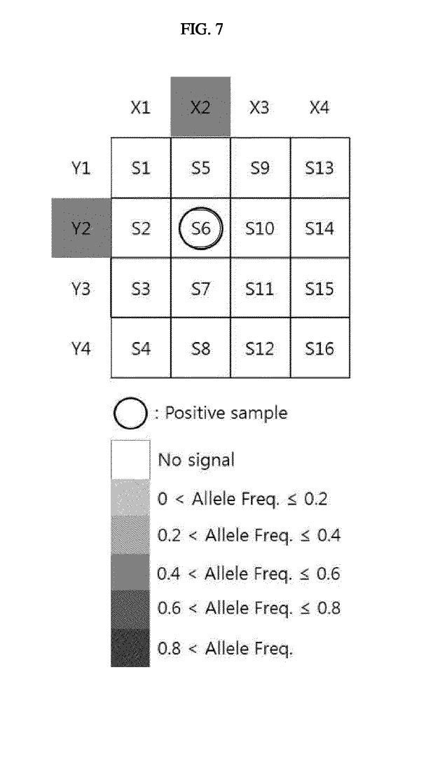

FIGS. 7 to 9 are diagrams illustrating an exemplary signal pattern in a sample pooling test according to embodiments of the present disclosure.

First, FIG. 7 illustrates a case in which samples have a rare variation. In this case, most pools X1, X3, X4, Y1, Y3, and Y4 show the alternative allele frequency of about 0, and some pools X2 and Y2 show the alternative allele frequency of about 0.4 to 1. Therefore, in this case, the signal pattern determining unit 106 may determine that a corresponding pool has the effective signal pattern.

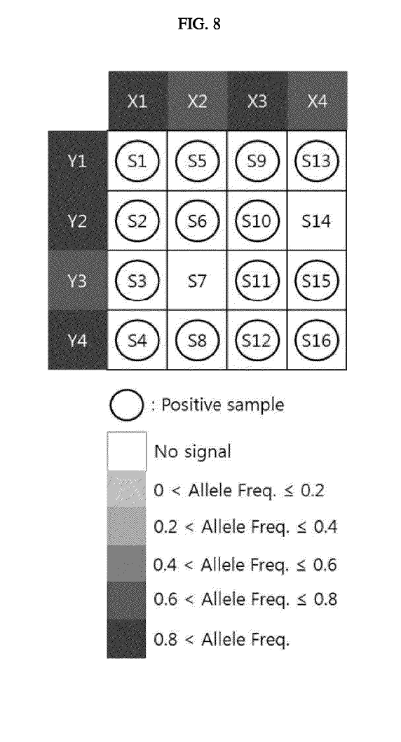

Next, FIG. 8 illustrates a case in which a high level of the alternative allele frequency is shown in all pools. This is a case in which an accurate result may not be obtained (in other words, a case in which too many false positive samples are shown) by a sample pooling method since the number of positive samples among all samples is too large. In this case, the signal pattern determining unit 106 may determine that a corresponding pool has no effective signal pattern since there is no cluster having an average of 0 even when clustering is performed based on the alternative allele frequency of pools.

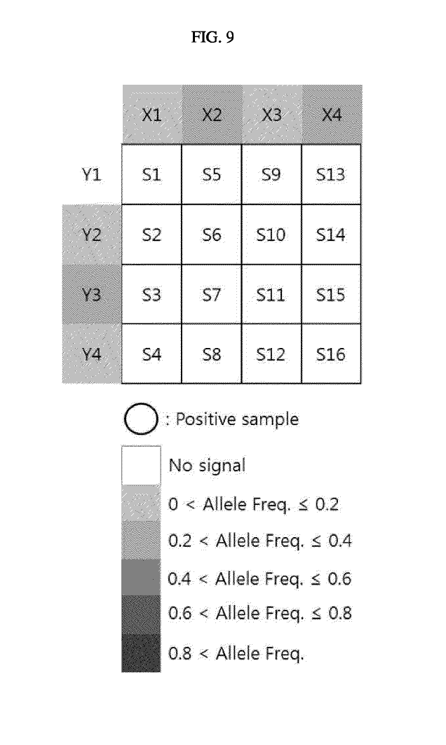

Next, FIG. 9 illustrates a case in which a low level of the alternative allele frequency is shown in most pools. This is a case in which there is actually no positive sample, but a low alternative allele frequency is shown in the pools due to a systematic error and the like. In this case, even when clustering is performed based on the alternative allele frequency of pools, since there is no cluster having an average of 0.4 to 1, the signal pattern determining unit 106 may determine that a corresponding pool has no effective signal pattern.

As described above, in order to check whether the alternative allele frequency of each pool shows the effective signal pattern, the signal pattern determining unit 106 may cluster pools into two clusters using a clustering algorithm based on the alternative allele frequency thereof. For example, the signal pattern determining unit 106 may perform clustering using a K-mean clustering algorithm that is one type of a data mining technique, but this is only an example and the present disclosure is not limited thereto. Then, the signal pattern determining unit 106 calculates an average of alternative allele frequencies of pools corresponding to each cluster. For example, when an average value of cluster 1 is close to about 0 and an average value of cluster 2 is shown as a significant level for standard variation detection (about 0.4 to 1), the signal pattern determining unit 106 may determine that there is the effective signal pattern and perform a subsequent operation: in depth variation detection. In depth variation detection in pool (Deep Call)

When the error determining unit 104 determines that there is the error possibility or the signal pattern determining unit 106 determines that the alternative allele frequency of the plurality of pools has the effective signal pattern, the second variation detecting unit 108 determines whether each of the plurality of pools has the test target property according to a second determining reference value that is a value lower than the first determining reference value. However, depending on embodiments, if the signal pattern determining unit 106 is not included in the sample analyzing system 100, when the error determining unit 104 determines that there is the error possibility, the second variation detecting unit 108 may be configured to directly determine whether each of the plurality of pools has the test target property according to the second determining reference value.

The second variation detecting unit 108 may detect a variation in each pool using the same algorithm as the first variation detecting unit 102. However, unlike the first variation detecting unit 102, the second variation detecting unit 108 may be configured to detect a variation when a signal intensity having a certain level or more is observed even when the signal intensity of a significant level that is necessary for standard detection is not observed. In other words, the second determining reference value in the second variation detecting unit may be a value that is lower than or decreased from the first determining reference value.

For example, it is assumed that the first variation detecting unit 102 and the second variation detecting unit 108 detect a variation using Equation 1. When the first variation detecting unit 102 applies 0.5 as an α value, the second variation detecting unit 108 may apply a decreased value of about 0.1 to 0.2. In this case, when the alternative allele frequency of the specific pool is observed as 0.4, the first variation detecting unit 102 determines that the corresponding pool is negative, and the second variation detecting unit 108 determines that the corresponding pool as positive. However, alternatively, the second variation detecting unit 108 may be configured to detect a variation in each pool using a different algorithm from the first variation detecting unit 102.

### Determination of Variation of Each Sample

Next, the test result determining unit 110 determines whether each of the plurality of samples has the test target property according to the determination results of the first variation detecting unit 102 and the second variation detecting unit 108. The method of determining whether each sample has the test target property using the test result of each pool has been described above.

Meanwhile, in order to more accurately determine whether each sample has a variation, when the positive sample is determined, the number of pools in which a variation is detected by in depth detection among pools in which the corresponding sample is pooled may be limited. For example, it is assumed that the number of pools in which a variation is detected by in depth detection is limited to 1. To be the positive sample, at least one of two pools in which the corresponding sample is pooled should be determined as positive in the first variation detecting unit 102. This is because, when the second variation detecting unit 108 determines whether the sample is positive using only the positive pool, a possibility of determining a false positive increases.

The system for analyzing a biological sample 100 according to embodiments of the present disclosure is especially beneficial when it is difficult to know whether the variation detected in the pool is a rare variation related to an incidence of a disease or a variation commonly found in a normal population.

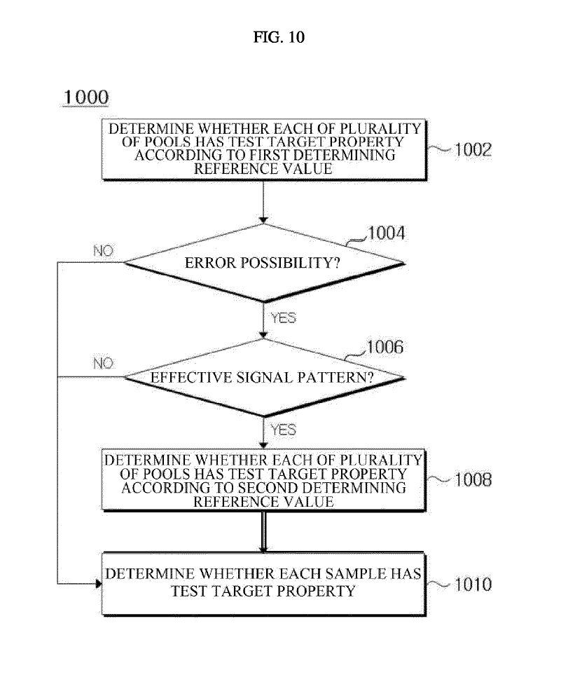

FIG. 10 is a flowchart illustrating a method of analyzing a biological sample 1000 according to an embodiment of the present disclosure.

In operation 1002, the first variation detecting unit 102 determines whether each of the plurality of pools has the test target property according to a preset first determining reference value.

In operation 1004, the error determining unit 104 determines whether there is an error possibility in the determination result of the first variation detecting unit according to the alternative allele frequency of the pool that is determined as positive in the first variation detecting unit 102. When it is determined in operation 1004 that there is no error possibility, the process directly advances to operation 1010.

On the other hand, when it is determined in operation 1004 that there is the error possibility, the signal pattern determining unit 106 determines whether the alternative allele frequency of the plurality of pools has the effective signal pattern in operation 1006. When it is determined in operation 1006 that there is no effective signal pattern, the process directly advances to operation 1010.

On the other hand, when it is determined in operation 1006 that there is the effective signal pattern, the second variation detecting unit 108 determines whether each of the plurality of pools has the test target property according to a second determining reference value in operation 1008.

In operation 1010, the test result determining unit 110 determines whether each of the plurality of samples has the test target property according to the determination results of the first variation detecting unit 102 and/or the second variation detecting unit 108.

According to embodiments of the present disclosure, even when a signal of a significant level is not observed in any pool among cross pools in which a positive sample is pooled, it is possible to additionally check whether a corresponding pool is positive through in depth detection of a variation. Therefore, it is possible to minimize a possibility of determining a false negative or a false positive for some samples in the pooling test. As a result, it is possible to increase sensitivity of the test.

Meanwhile, the embodiments of the present disclosure may include a computer readable recording medium including a program for executing methods described in this specification in a computer. The computer readable recording medium may include a program instruction, a local data file, and a local data structure, and/or combinations thereof. The medium may be specially designed and prepared for the present disclosure or an available medium that is known those skilled in the field of computer software. Examples of the computer readable recording medium include magnetic media such as a hard disk, a floppy disk, and a magnetic tape, optical media such as a CD-ROM and a DVD, magneto-optical media such as a floptical disk, and a hard device such as a ROM, a RAM, or a flash memory, that is specially made to store and perform the program instruction. Examples of the program instruction may include a machine code generated by a compiler and a high-level language code that can be executed in a computer using an interpreter.

While the present disclosure has been described above in detail with reference to representative embodiments, it may be understood by those skilled in the art that the embodiments may be variously modified without departing from the scope of the present disclosure.

Therefore, the scope of the present disclosure is defined not by the described embodiments but by the appended claims, and encompasses equivalents that fall within the scope of the appended claims.

What is claimed is:

1. A system for analyzing biological samples, the system comprising:
a first variation detector configured to determine whether a pool of the samples has a test target property based on a first determining reference value;
an error determining processor configured to determine whether a probability of error exists in a determination of the first variation detector based on an alternative allele frequency of the pool in response to the first variation detector determining the pool as positive;
a second variation detector configured to determine whether the pool has the test target property based on a second determining reference value in response to the error determining processor determining the probability of error exists; and
a test result determining processor configured to determine whether each of the samples has the test target property based on the determination of the first variation detector and a determination of the second variation detector.

2. The system of claim 1, wherein the error determining processor compares an alternative allele frequency of the pool determined as positive and a number of samples determined as positive in the pool.

3. The system of claim 1, further comprising a signal pattern determining processor configured to determine whether an alternative allele frequency of a plurality of pools including the samples has an effective signal pattern in response to the error determining processor determining that the probability of error exists.

4. The system claim 3, wherein the signal pattern determining processor groups alternative allele frequencies of each of the plurality of pools into two clusters and determines whether an effective signal pattern exists based on an average value of alternative allele frequencies for each of the two clusters.

5. The system of claim 4, wherein the signal pattern determining processor determines that the effective signal pattern exists in response an average value of alternative allele frequencies of the pools in one of the two clusters being a value in a range from 0 to 0.1 and an average value of alternative allele frequencies of the pools in the other cluster being a value in a range from 0.4 to 1.

6. The system of claim 3, the second variation detector determines whether each of the plurality of pools has the test target property based on the second determining reference value in response to the signal pattern determining processor determining that the alternative allele frequency of the plurality of pools has the effective signal pattern.

7. The system of claim 1, wherein the second determining reference value is a value smaller than the first determining reference value.

8. A method of analyzing biological samples, the method comprising:
first variation determining, by a first variation detector, whether a pool of the samples has a test target property based on a first determining reference value;
determining, by an error determining processor, whether a probability of error exists in a determination of the first variation detector based on an alternative allele frequency of the pool in response to the first variation detector determining the pool as positive;
second variation determining, by a second variation detector, whether the pool has the test target property based on a second determining reference value in response to the error determining processor determining that the probability of error exists; and
determining, by a test result determining processor, whether each of the samples has the test target property based on the determination of the first variation detector and a determination of the second variation detector.

9. The method of claim 8, wherein the determining of whether the probability of error exists comprises comparing an alternative allele frequency of the pool determined as positive and a number of samples determined as positive in the pool.

10. The method of claim 8, further comprising determining, by a signal pattern determining processor, whether an alternative allele frequency of a plurality of pools including the samples has an effective signal pattern in response to the error determining processor determining that the probability of error exists.

11. The method of claim 10, wherein the determining whether the alternative allele frequency of the plurality of pools has the effective signal pattern comprises grouping alternative allele frequencies of each of the plurality of pools into two clusters, and determining whether an effective signal pattern exists using an average value of alternative allele frequencies for each of the two clusters.

12. The method of claim 11, wherein the determining whether the alternative allele frequency of the plurality of pools has the effective signal pattern comprises determining that the effective signal pattern exists in response to an average value of an alternative allele frequencies of the pools in one of the two clusters being a value in a range from 0 to 0.1 and an average value of an alternative allele frequencies of the pools in the other cluster being a value in a range from 0.4 to 1.

13. The method of claim 10, wherein the second variation determining comprises determining whether each of the plurality of pools has the test target property based on the second determining reference value in response to the signal pattern determining processor determining that the alternative allele frequency of the plurality of pools has the effective signal pattern.

14. The method of claim 8, wherein the second determining reference value is a value smaller than the first determining reference value.

15. An analyzer for analyzing biological samples grouped by a plurality of pools, the analyzer comprising:
a first variation detector configured to determine that one of the plurality of pools has a target property based on a first reference value;
a signal pattern processor configured to determine that an alternative allele frequency of the plurality of pools has an effective signal pattern;
a second variation detector configured to determine that the one of the plurality of pools has the target property based on a second reference value in response to the signal pattern processor determining that the alternative allele frequency has the effective signal pattern; and
a test result determining processor configured to determine whether each of the samples has the target property based on determinations of the first variation detector and the second variation detector.

16. The analyzer of claim 15, wherein the signal pattern determining processor groups alternative allele frequencies of each of the plurality of pools into two clusters and determines whether an effective signal pattern exists based on an average value of alternative allele frequencies for each of the two clusters.

17. The analyzer of claim 16, wherein the signal pattern determining processor determines that the effective signal pattern exists in response an average value of alternative allele frequencies of the pools in one of the two clusters being a value in a range from 0 to 0.1 and an average value of the alternative allele frequencies of the pools in the other cluster being a value in a range from 0.4 to 1.

18. The analyzer of claim 15, the second variation detector determines whether each of the plurality of pools has the target property based on the second reference value in response to the signal pattern determining processor determining that the alternative allele frequency has the effective signal pattern.

19. The system of claim 15, wherein the second reference value is a value smaller than the first reference value.
